(19) United States
(12) Patent Application Publication
(10) Pub. No.: US 2026/0141291 A1
(43) Pub. Date: May 21, 2026

(54) MULTI-TENANT SYSTEM FOR WELL INTERVENTION CANDIDATE SCREENING AND RANKING

(71) Applicant: Schlumberger Technology Corporation, Sugar Land, TX (US)

(72) Inventors: Abhay Paroha, Houston, TX (US); Rajeev Ranjan Sinha, Houston, TX (US); Janaat Vijayakumar, Houston, TX (US); Casey Yancey, Houston, TX (US); Eugene Von Niederhausern, Houston, TX (US)

(21) Appl. No.: 18/954,700

(22) Filed: Nov. 21, 2024

(51) Int. Cl. G06N 20/00; G06Q 10/0639

(52) U.S. Cl. CPC G06N 20/00; G06Q 10/06393

(57) ABSTRACT

The present disclosure relates to systems and methods for automatically identifying candidate wells for intervention opportunities in a field. The systems and methods use machine learning models to automate the data analysis to identify the candidate wells. The systems and methods provide insights for the candidate wells and recommendations for the intervention opportunities.

### BACKGROUND OF THE DISCLOSURE

Wellbores are commonly drilled from a surface location or seabed for various exploration and extraction activities. These wellbores are used to access and extract fluid resources like liquid and gaseous hydrocarbons from subterranean formations. The construction of wellbores involves the use of earth-boring equipment such as drill bits for initial drilling and reamers for enlarging the wellbore diameters.

Well interventions provide well diagnostics and manages the production of the well to improve or maintain the productivity of a well. Operators face many challenges when selecting well intervention candidates and evaluating a field's potential because the process is highly time-consuming, labor-intensive, and susceptible to cognitive biases.

### SUMMARY

This summary is provided to introduce a selection of concepts that are further described in the detailed description. This summary is not intended to identify key or essential features of the claimed subject matter, nor is it intended to be used as an aid in limiting the scope of the claimed subject matter.

Some implementations relate to a method. The method includes performing, using a machine learning model, analysis on data for wells in a field. The method includes automatically identifying, using the machine learning model, candidate wells for intervention opportunities in response to the analysis. The method includes performing, using the machine learning model, an analytic hierarchy process that uses a set of key performance indicators to generate a rank for the candidate wells. The method includes generating, using the machine learning model, a recommendation for the candidate wells and a predicted success of the recommendation, wherein the recommendation includes an action for intervention. The method includes displaying, on a user interface, the rank of the candidate wells, the recommendation, and the predicted success of the recommendation. The method includes receiving a selection of a candidate well in response to the rank and predicted success of the recommendation. The method includes scheduling the action for intervention for the candidate well.

Some implementations relate to a system. The system includes a memory to store data and instructions; and a processor operable to communicate with the memory, wherein the processor is operable to: perform, using a machine learning model, analysis on data for wells in a field; automatically identify, using the machine learning model, candidate wells for intervention opportunities in response to the analysis; perform, using the machine learning model, an analytic hierarchy process that uses a set of key performance indicators to generate a rank for the candidate wells; generate, using the machine learning model, a recommendation for the candidate wells and a predicted success of the recommendation, wherein the recommendation includes an action for intervention; display, on a user interface, the rank of the candidate wells, the recommendation, and the predicted success of the recommendation; receive a selection of a candidate well in response to the rank and predicted success of the recommendation; and schedule the action for intervention for the candidate well.

Some implementations relate to a computer-readable storage medium including instructions that, when executed by a processor, cause the processor to: perform, using a machine learning model, analysis on data for wells in a field; automatically identify, using the machine learning model, candidate wells for intervention opportunities in response to the analysis; perform, using the machine learning model, an analytic hierarchy process that uses a set of key performance indicators to generate a rank for the candidate wells; generate, using the machine learning model, a recommendation for the candidate wells and a predicted success of the recommendation, wherein the recommendation includes an action for intervention; display, on a user interface, the rank of the candidate wells, the recommendation, and the predicted success of the recommendation; receive a selection of a candidate well in response to the rank and predicted success of the recommendation; and schedule the action for intervention for the candidate well.

Additional features and aspects of implementations of the disclosure will be set forth herein, and in part will be obvious from the description, or may be learned by the practice of such implementations. The features and advantages of such implementations may be realized and obtained by means of the instruments and combinations particularly pointed out in the appended claims. These and other features will become more fully apparent from the following description and appended claims, or may be learned by the practice of such implementations as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is an example of a downhole system in accordance with implementations of the present disclosure.

FIG. 2 illustrates an example environment for a well intervention tool in accordance with implementations of the present disclosure.

FIG. 3 illustrates an example workflow of a well intervention tool in accordance with implementations of the present disclosure.

FIG. 4 illustrates an example analytic hierarchy process in accordance with implementations of the present disclosure.

FIG. 5 illustrates an example environment for a multi-tenant well intervention tool in accordance with implementations of the present disclosure.

FIGS. 6A-6C illustrate example graphical user interfaces of insights in accordance with implementations of the present disclosure.

FIGS. 7A-7E illustrate example graphical user interfaces of user interface widgets in accordance with implementations of the present disclosure.

FIG. 8 illustrates an example method for automatically identifying an intervention job in accordance with implementations of the present disclosure.

FIG. 9 illustrates an example environment for a multi-tenant well intervention tool in accordance with implementations of the present disclosure.

FIG. 10 illustrates an example method for automatically identifying candidate wells for intervention opportunities in accordance with implementations of the present disclosure.

FIG. 11 illustrates components that may be included within a computer system.

### DETAILED DESCRIPTION

This disclosure generally relates to systems and methods for well intervention. Well interventions provide well diagnostics and manages the production of the well to improve or maintain the productivity of a well. Well interventions are well-maintenance services such as stimulation, zonal isolation, wellbore cleanout, reinstatement, etc., which are performed in the field to address the production issues and ensure a constant production rate for a longer duration.

Operators face many challenges when selecting well intervention candidates and evaluating a field's potential because the process is highly time-consuming, labor-intensive, and susceptible to cognitive biases. A typical lifecycle of a field can be classified into various stages based on the activities carried out during the stages (Exploration, Appraisal, Development, Production, and Abandonment). A significant amount of investment is made by the operators in the first few phases with the negative cash-flow peak at the development phase. Typically, the production stage with the first commercial production of hydrocarbons generates cash, and the cash generated is used to pay back the prior investments and for future development and operations.

The production phase consists of three periods (the production buildup, plateau production, and production decline) and plays a role in deciding the overall project economics. The production buildup is a period during which daily production rate increases with time because new production wells are continuously introduced in the field. The plateau production is the period during which a constant and high production rate is maintained. The production decline is the period of production phase during which most of the wells start experiencing production challenges and the overall production rate declines with time. Ultimately, the production rate declines to a point where further production can no longer cover the operating costs. The wells are then abandoned, and the field is decommissioned.

Production decline is the longest and a crucial period of the production phase. During the decline phase, most of the wells are underproducing and do not meet their expected targets for various reasons, which ultimately affects the overall field production. Therefore, reducing the rate of production decline with the appropriate well intervention technique is one of the objectives for operators to maintain the required production rate and increase the overall life of the field. Examples of well interventions include well-maintenance services, such as, stimulation, zonal isolation, wellbore cleanout, reinstatement, etc., which are regularly performed in the field to address the production issues and ensure a constant production rate for a longer duration.

Well interventions are usually performed with tools such as coiled tubing, wireline, hydraulic concentric pumps, workover rigs, etc. In a field, many wells may require simultaneous maintenance, and the available well intervention tools may be limited in number and come with high operating costs. Therefore, a well intervention is performed after a long approval cycle and a detailed technical, operational, and economic analysis. It is also important to ensure a quick response from the well-services team when there is a production issue with high-producing wells. A longer waiting period for a service can intensify the production issues and may lead the well to become permanently inactive.

A tradeoff between quick response and detailed (time-consuming) analyses makes intervention planning very complex and labor-intensive. One challenge for any operator is to timely identify the sick wells, the corresponding production issue, and the type of well intervention. These are multidisciplinary activities where multiple teams such as reservoir, geology, production, facility, etc. work together and perform a well review. Well intervention candidates are selected, and intervention opportunities are identified after performing several engineering analyses on the available data.

When a well is underperforming (sick well) even after operating at the optimum operational conditions, engineers are tasked with identifying the factors affecting the well performance. In some cases, the well performance is caused by declining reservoir pressure; in other cases, the well performance is because of production issues. If other wells producing from the same reservoir are not experiencing a similar decline in daily production rate, then there is a high probability that the issue is related to the production. In such scenarios, performing a well intervention on sick wells can raise the production rate of the sick wells back to normal. However, every well has its own set of constraints that need to be identified before performing any intervention job. For example, a well intervention performed on a well with good mechanical integrity can lead to the desired results, whereas the same job performed on a sick well can cause casing/tubing leaks, jeopardize the well's life, and result in a serious health, safety, and environmental incident if the well integrity is compromised. Therefore, well intervention selection is a crucial process, and several engineering analyses are performed before executing the job.

The entire process for well intervention is very time consuming (can take from weeks to months) and requires a lot of manual effort to select the top intervention candidates. In the case of high-well-count assets, the well intervention process becomes more tedious, and the realization of well intervention opportunities may take up to a year. Considerable time lag may occur between review and execution, and the actual realization of production potential.

The systems and methods of the present disclosure provide an automated system for well intervention candidate screening and ranking. In some implementations, a well intervention tool automatically identifies candidate wells for intervention and provides one or more recommendations with actions for intervention. In some implementations, machine learning models are used by the well intervention tool to automatically identify candidate wells and provide recommendations for the intervention opportunities. As will be discussed in further detail below, the present disclosure includes a number of practical applications having features described herein that provide benefits and/or solve problems associated with well interventions.

Some example benefits are discussed herein in connection with various features and functionalities provided by the well intervention tool implemented on one or more computing devices. It will be appreciated that benefits explicitly discussed in connection with one or more implementations described herein are provided by way of example and are not intended to be an exhaustive list of all possible benefits of the well intervention tool. For example, one benefit includes automatically screening and ranking candidate wells for intervention opportunities. The well intervention tool rapidly screens and ranks hundreds to thousands of performance-improvement opportunities. Another example benefit includes using machine learning models to automate the execution of petroleum engineering analysis. The well intervention tool eliminates cognitive bias and reduces hundreds of hours of manual work to a few minutes of automated computation.

In some implementations, the well intervention tool supports multiple tenants and automatically identifies candidate wells for intervention opportunities for different tenants. The well intervention tool uses a fully automated workflow to identify well-intervention opportunities. The well intervention tool uses an analytic hierarchy process to rank candidate wells for the intervention opportunities. In some implementations, the well intervention tool uses a hybrid approach that integrates petroleum engineering analysis methods, best practices, machine learning algorithms, and the operator's business logic. In some implementations, the workflows read input data, perform the data analysis on the data, and save the results of the workflow to the well intervention tool. In some implementations, the well intervention tool supports customization of the workflows based on preferences of the user or a tenant supporting flexible data flows. The well intervention ensures data integrity while supporting flexible entity types in the data used by the well intervention tool. For example, the well intervention tool supports flexible data hierarchies and customized data properties.

The well intervention tool provides a user interface with the identified candidate wells, insights derived for the candidate wells, and recommendations for the intervention opportunities. Users may use the information provided on the user interface to select a candidate well for intervention, perform the recommended actions, and/or modify drilling operations. In some implementations, the well intervention tool supports customization of the user interface. For example, the user customizes the forms, page layouts, the content of the widgets for the preferences of the user. The user may easily modify or change the user interface of the well intervention tool based on preferences of the user.

One of the technical advantages of the systems and methods of the present disclosure is isolation of data among users. The well intervention tool supports multi-tenants and isolates the data among the different tenants preventing unauthorized data access among the tenants. Another technical advantage of the systems and methods of the present disclosure is the customization of the well intervention tool among the tenants. For example, the well intervention tool supports customization of workflows and a user interface allowing the workflows and the user interface to differ among the tenants. One example of the customization is visualization customization of the well intervention tool. The visualization customization is customized within the context of the application customizing the pages and widgets in the applications. The visualization customization can be performed by users without coding experience. Another example of the customization is workflow customization. The workflow customization aids in the creation of complex workflows that perform calculations and data transformations. The workflows access data by reading data from the data sources and saving the results. The workflow customization can be performed by users without coding experience. Another example of the customization is data customization that is available for use in well intervention tool for workflows and visualization. The data customization allows augmentation of the data with new data elements (e.g., timeseries, structured, unstructured) and augmentation of the data with new types. The workflows may also produce new data elements that are available for use with the well intervention tool. Another technical advantage of the systems and methods of the present disclosure is saving of compute costs. By running one workflow that is customizable to different tenants, the compute costs are reduced.

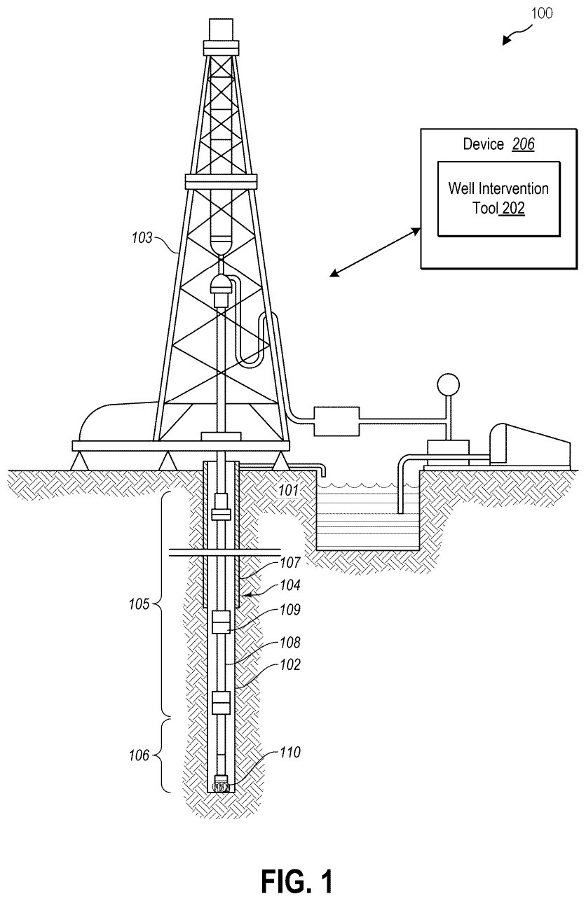

Additional details will now be provided regarding systems described herein in relation to illustrative figures portraying example implementations. For example, FIG. 1 shows one example of a downhole system 100 for drilling an earth formation 101 to form a wellbore 102. The downhole system 100 includes a drill rig 103 used to turn a drilling tool assembly 104 which extends downward into the wellbore 102. The drilling tool assembly 104 may include a drill string 105, a bottomhole assembly (“BHA”) 106, and a bit 110, attached to the downhole end of the drill string 105.

The drill string 105 may include several joints of drill pipe 108 connected end-to-end through tool joints 109. The drill string 105 transmits drilling fluid through a central bore and transmits rotational power from the drill rig 103 to the BHA 106. In some implementations, the drill string 105 further includes additional downhole drilling tools and/or components such as subs, pup joints, etc. The drill pipe 108 provides a hydraulic passage through which drilling fluid is pumped from the surface. The drilling fluid discharges through selected-size nozzles, jets, or other orifices in the bit 110 for the purposes of cooling the bit 110 and cutting structures thereon, and for lifting cuttings out of the wellbore 102 as it is being drilled.

The BHA 106 may include the bit 110, other downhole drilling tools, or other components. An example BHA 106 may include additional or other downhole drilling tools or components (e.g., coupled between the drill string 105 and the bit 110). Examples of additional BHA components include drill collars, stabilizers, measurement-while-drilling (“MWD”) tools, logging-while-drilling (“LWD”) tools, downhole motors, underreamers, section mills, hydraulic disconnects, jars, vibration or dampening tools, other components, or combinations of the foregoing.

In general, the downhole system 100 may include other downhole drilling tools, components, and accessories such as special valves (e.g., kelly cocks, blowout preventers, and safety valves). Additional components included in the downhole system 100 may be considered a part of the drilling tool assembly 104, the drill string 105, or a part of the BHA 106, depending on their locations in the downhole system 100.

The bit 110 in the BHA 106 may be any type of bit suitable for degrading downhole materials. For instance, the bit 110 may be a drill bit suitable for drilling the earth formation 101. Example types of drill bits used for drilling earth formations are fixed-cutter or drag bits. In other implementations, the bit 110 may be a mill used for removing metal, composite, elastomer, other materials downhole, or combinations thereof. For instance, the bit 110 may be used with a whipstock to mill into casing 107 lining the wellbore 102. The bit 110 may also be a junk mill used to mill away tools, plugs, cement, other materials within the wellbore 102, or combinations thereof. Swarf or other cuttings formed by use of a mill may be lifted to the surface 111 or may be allowed to fall downhole. The bit 110 may include one or more cutting elements for degrading the earth formation 101.

The BHA 106 may further include a rotary steerable system (RSS). The RSS may include directional drilling tools that change a direction of the bit 110, and thereby the trajectory of the wellbore. At least a portion of the RSS may maintain a geostationary position relative to an absolute reference frame, such as one or more of gravity, magnetic north, or true north. Using measurements obtained with the geostationary position, the RSS may locate the bit 110, change the course of the bit 110, and direct the directional drilling tools on a projected trajectory. The RSS may steer the bit 110 in accordance with or based on a trajectory for the bit 110. For example, a trajectory may be determined for directing the bit 110 toward one or more subterranean targets such as an oil or gas reservoir.

The downhole system 100 may provide information (e.g., measurements from sensors) to a well intervention tool 202 accessible via a device 206. In some implementations, the well intervention tool 202 is on a remote server in communication with the downhole system 100 using the device 206 via a network. The well intervention tool 202 facilitates users with identifying whether the downhole system 100 is a candidate for well intervention.

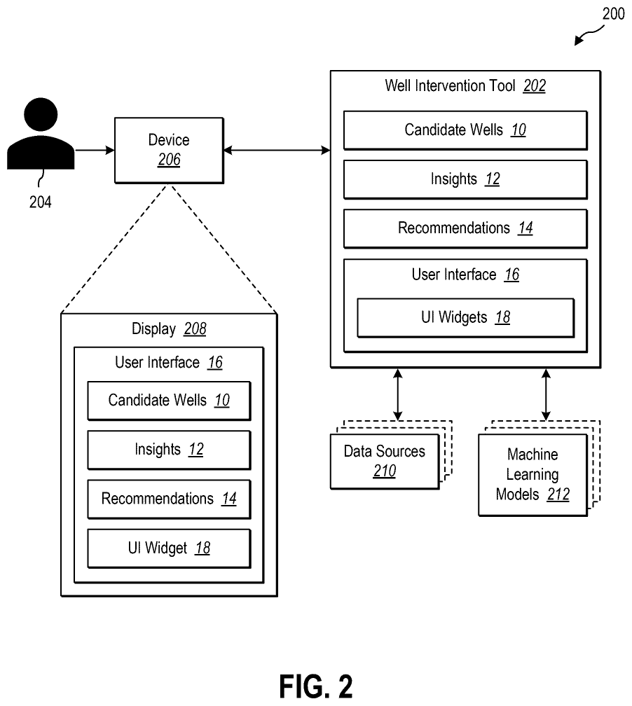

FIG. 2 illustrates an example environment 200 for a well intervention tool 202. The well intervention tool 202 automates the process of identifying intervention opportunities by identifying candidate wells 10 in a field for well intervention and provides recommendations 14 for the candidate wells 10. Candidate wells 10 are wells that are underperforming. For example, an underperforming well is producing under a target production rate. One example of a candidate well 10 is the downhole system 100 (FIG. 1). Another example of a candidate well 10 is a subsea well. In some implementations, a field can include a plurality of wells where one or more wells are identified by the well intervention tool 202 as candidate wells 10.

The well intervention tool 202 receives data from different data sources 210. In some implementations, the well intervention tool 202 is on a server in communication with the different data sources 210 through a network. In some implementations, the well intervention tool 202 is on a cloud server remote from the different data sources 210 accessed through the network. For example, the well intervention tool 202 is hosted on virtual machines in the cloud. In some implementations, the well intervention tool 202 is on an edge device at the field or a well.

The network may include one or multiple networks and may use one or more communication platforms and/or technologies suitable for transmitting data. The network may refer to any data link that enables transport of electronic data between devices of the environment 200. The network may refer to a hardwired network, a wireless network, or a combination of a hardwired network and a wireless network. In one or more implementations, the network includes the internet. The network may be configured to facilitate communication between the various computing devices via well-site information transfer standard markup language (WITSML) or similar protocol, or any other protocol or form of communication. The server may include one or more computing devices (e.g., including processing units, data storage, etc.) organized in an architecture with various network interfaces for connecting to and providing data management and distribution across one or more client systems.

In some implementations, the well intervention tool 202 uses one or more machine learning models 212 to analyze the data received from the data sources 210 and identifying candidate wells 10 for intervention. In some implementations, the well intervention tool 202 uses one or more machine learning models 212 to provide insights 12 for the intervention and/or recommendations 14 for the intervention. The well intervention tool 202 uses adaptive data analytics and the machine learning models 212 to automate identifying candidate wells 10 for intervention. The well intervention tool 202 uses the machine learning models 212 to leverage the data from workover history and customizable business logics to perform economic analyses and predict post-workover production, success probability, and profitability. Using machine learning models 212 to identify the candidate wells 10 and provide insights 12 and/or recommendations 14 reduces cognitive bias in the process and reduces the hundreds of hours of manual work to a few minutes of automated computation.

A user 204 accesses the well intervention tool 202 using a device 206. The device 206 may be representative of one or multiple devices and may refer to various types of computing devices. For example, the device 206 may include a mobile device such as a mobile telephone, a smartphone, a personal digital assistant (PDA), a tablet, a laptop, or any other portable device. Additionally, or alternatively, the device 206 may include one or more non-mobile devices such as a desktop computer, server device, surface or downhole processor or computer (e.g., associated with a sensor, system, or function of the downhole system), or other non-portable device.

In one or more implementations, a user interface 16 is displayed on a display 208. The device 206 may be communicatively coupled (e.g., wired or wirelessly) to the display 208 having the user interface 16 thereon for providing a display of system content.

In some implementations, the well intervention tool 202 is on a cloud server remote from the device 206 of the user 204 accessed through the network. For example, a uniform resource locator (URL) configured to an end point of the well intervention tool 202 is provided to the device 206 that the user 204 may access using a browser on the device 206. Another example includes an application on the device 206 of the user 204 providing access to the well intervention tool 202.

In some implementations, the well intervention tool 202 is a cloud-hosted multi-tenant application that uses a shared cloud infrastructure to provide access to the well intervention tool 202 to multiple users 204. The well intervention tool 202 supports customization at the data level, workflow level, and the user interface 16. For example, the users 204 can customize and configure different UI widgets 18 as per their use case. Another example includes the users 204 can customize the workflows used to identify the candidate wells 10 by the well intervention tool 202. Another example includes the users 204 can customize the data sources 210 used to identify the candidate wells 10.

The user 204 can view the candidate wells 10, the insights 12, and any recommendations 14 displayed on the user interface 16. In some implementations, the user 204 uses the insights 12 or the recommendations 14 to modify the drilling operations of the candidate wells 10. The environment 200 provides an automated system for well intervention candidate screening and ranking for intervention opportunities.

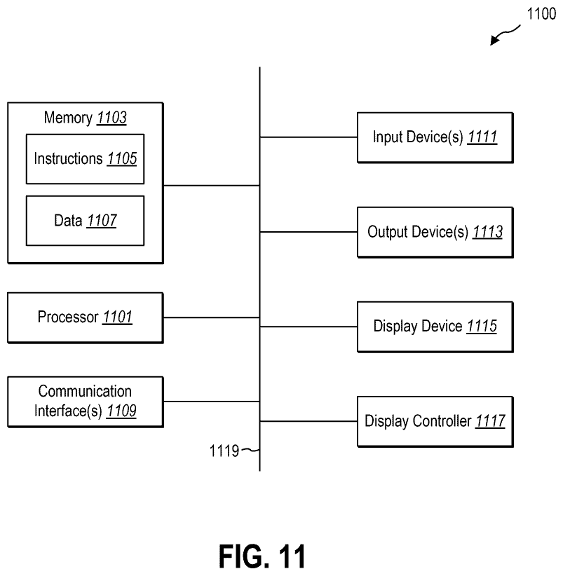

In some implementations, one or more computing devices (e.g., servers and/or devices) are used to perform the processing of the environment 200. The one or more computing devices may include, but are not limited to, server devices, cloud virtual machines, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. For example, the well intervention tool 202 is implemented on a single computing device. Moreover, in some implementations, one or more subcomponents of the feature and functionalities discussed herein may be implemented and processed on different server devices of the same or different cloud computing networks. For example, the well intervention tool 202 is implemented on different server devices. In this way, the environment 200 may be a cloud computing environment, and the well intervention tool 202 may be implemented across one or more devices of the cloud computing environment in order to leverage the processing capabilities, memory capabilities, connectivity, speed, etc., that such cloud computing environments offer in order to facilitate the features and functionalities described herein. Each of the devices of the environment 200 may include features and/or functionalities described below in connection with FIG. 11.

In some implementations, each of the components of the environment 200 is in communication with each other using any suitable communication technologies. In addition, while the components of the environment 200 are shown to be separate, any of the components or subcomponents may be combined into fewer components, such as into a single component, or divided into more components that may serve a particular implementation. In some implementations, the components of the environment 200 include hardware, software, or both. For example, the components of the environment 200 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 200 include hardware, such as a special purpose processing device to perform a certain function or group of functions. In some implementations, the components of the environment 200 include a combination of computer-executable instructions and hardware.

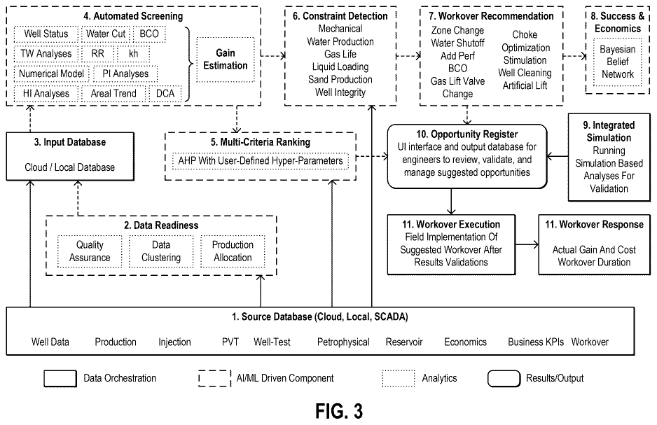

FIG. 3 illustrates an example workflow 300 of a well intervention tool 202 (FIG. 2). In some implementations, the workflow 300 is a multi-tenant workflow that uses a shared cloud infrastructure to provide access to multiple customers. The multi-tenant workflow provides an ability to end users in multiple tenants to customize and configure the workflow 300 as per their specific use case.

The workflow 300 is a standardized, domain-driven, and fully automated approach to well-intervention opportunity management. The workflow 300 is designed to rapidly screen and rank hundreds to thousands of wells for performance-improvement opportunities. The workflow 300 maintains a full and prioritized pipeline of production enhancement opportunities (e.g., the candidate wells 10 (FIG. 2)) and expedites candidates through the opportunity maturation process. In some implementations, the workflow 300 uses a hybrid approach that integrates petroleum engineering analysis methods, best practices, machine learning algorithms, and the operator's business logic.

At 1, the workflow 300 includes data sourcing. The well intervention tool 202 obtains data from different data sources 210 (FIG. 2). In some implementations, the data sources 210 are on-premises servers, cloud storage, or in the form of spreadsheets. In some implementations, multidisciplinary input data from different sources (production reports, reservoir databases, production, petrophysics, reservoir, and economics data etc.) is used to run the workflow 300. Data loaders are configured to pull the data from the different data sources 210 and ingest the data into a single centralized database for use with the well intervention tool 202. In some implementations, scheduled data loaders, for example, running at a daily frequency, a weekly frequency, or a monthly frequency, are configured to pull the data from all the different sources 210 and ingest the data into a centralized database.

At 2, the workflow 300 includes data readiness. The well intervention tool 202 prepares the data for input into the database. In some implementations, the well intervention tool 202 uses one or more machine learning models 212 to prepare the data for input. Before the required data is ingested into the input database, the well intervention tool 202 performs data cleaning to remove any invalid data as a part of data readiness.

For multifield operations, the well intervention tool 202 uses data clustering to group small fields (e.g., with less than 10 active wells) based on spatial distance and petrophysical property variations. Fields with more than 10 active wells can be run as an independent cluster. The well intervention tool 202 runs each cluster independently (e.g., data from wells of one cluster is independent from data of other clusters). The workflow 300 uses production data from each zone. For example, production data is usually available at the well level. The production allocation process enables the well intervention tool 202 to allocate well production volumes to subsurface zones based on productivity and well ratios [GOR, water/oil ratios (WOR)].

At 3, the workflow 300 includes storing the data in the input database. The well intervention tool 202 stores the data in the input database. In some implementations, the input database is a single centralized database for use with the well intervention tool 202. In some implementations, the data is stored after the data is cleaned and prepared for storing by the well intervention tool 202.

At 4, the workflow 300 includes automated screening and gain estimation wells in a field. The well intervention tool 202 performs the automated screening of wells in a field and identifies candidate wells 10 (FIG. 2) for intervention. The well intervention tool 202 provides a gain estimation for the candidate wells 10. In some implementations, the well intervention tool 202 uses one or more machine learning models 212 to run multiple petroleum engineering analyses (e.g., production analysis, injection analysis, reservoir analysis, and petrophysical analysis) on the data in the input database without user intervention to identify the candidate wells 10.

In some implementations, the well intervention tool 202 uses the machine learning models 212 to perform decline curve analysis (DCA) on the data. Decline curve analysis (DCA) is a graphical method to study the declining rate of oil or gas production from a well with respect to time. Historical production data is used to obtain the declining trend of production and is extrapolated (using exponential, hyperbolic, and harmonic functions) for production rate prediction, assuming a similar trend will continue in the future.

In some implementations, the well intervention tool 202 uses the machine learning models 212 to perform a type well (TW) curve analysis on the data. Type well (TW) curve analysis is a statistical approach to comparing the well-specific type-curve with that of other wells producing from the same reservoir. Depending on subsurface characteristics, the comparison group can be the entire field or broken down into subgroups such as production zones. The analysis is performed on the complete production history of production data to obtain P50, and P90 curves, representing optimistic, average, and conservative estimates of the production performance, respectively.

In some implementations, the well intervention tool 202 uses the machine learning models 212 to perform a heterogeneity index (HI) analysis on the data. Heterogeneity index (HI) analysis is the process of comparing the performance of an individual entity (well or completion) to the average performance of its peers in a predefined group (reservoir, zone, field, or wells on similar lift methods) as a function of time. HI analysis can be used as a quick evaluation tool to identify overperforming (HI>0) and underperforming (HI<0) wells.

In some implementations, the well intervention tool 202 uses the machine learning models 212 to perform a Chan plot analysis on the data. Chan water diagnostic plots are log-log plots of produced water/oil ratio (WOR) and WOR's derivative (rate of change of WOR) with time (days) as abscissae. In some implementations, the Chan plots are used to analyze water production issues in oil wells by categorizing the water production as normal, coning, channeling, breakthrough, etc. based on predefined empirical signatures. The trends can indicate the emergence of excessive subsurface water production mechanisms.

In some implementations, the well intervention tool 202 uses the machine learning models 212 to perform a productivity index analysis on the data. The productivity index (PI) is a parameter to quantify the ability of a well to produce. The productivity index can be used as a normalized measure of production performance where there is a change in artificial lift systems throughout a well history.

In some implementations, the well intervention tool 202 uses the machine learning models 212 to perform a voidage replacement ratio (VRR) plot analysis on the data. Voidage replacement ratio (VRR) is the ratio of volume of fluid injected to the volume of fluid produced from the reservoir. The VRR ratio is calculated using volumes in reservoir barrels and indicates the injection performance in a reservoir. Operators try to maintain VRR close to 1. If VRR is greater than 1, reservoir pressure should increase. If VRR is less than 1, reservoir pressure should decrease with time.

In some implementations, the well intervention tool 202 uses the machine learning models 212 to perform an after-before-compact (ABC) plot analysis on the data. An after-before-compact (ABC) plot uses production well test data from two different dates to compare the production rates. The ratio of oil production rates is calculated and plotted as ordinate, whereas the ratio of water production rates is calculated and plotted as abscissa. The location of wells on the plot is used to indicate the response of a producer to water injection.

In some implementations, the well intervention tool 202 uses the machine learning models 212 to perform a hall plot analysis on the data. Hall plot is derived from a radial flow equation of water from the wellbore. A hall plot is used to evaluate a performance of the injector based on the slope analysis of the plot between the cumulative pressure-time of injector and the cumulative water-injection volume. Any change in the slope indicates a change in injectivity behavior and can help to identify wells that may be plugging or that have been fractured during water injection.

In some implementations, the well intervention tool 202 uses the machine learning models 212 to perform reservoir and petrophysical analysis on the data. Areal trends of water cut, gas/oil ratio (GOR), permeability, porosity, net pay, static bottom hole pressure, etc. are mapped across the reservoir to find the potential hot spot for infill drilling and highlight the highest potential zone.

In some implementations, the well intervention tool 202 uses the machine learning models 212 to perform a well status analysis. In some implementations, the well intervention tool 202 uses the machine learning models 212 to perform a numerical model analysis. In some implementations, the well intervention tool 202 uses the machine learning models 212 to perform a remaining reserves (RR) analysis. In some implementations, the well intervention tool 202 uses the machine learning models 212 to perform permeability times pay thickness (kh) analysis. In some implementations, the well intervention tool 202 uses the machine learning models 212 to perform a water cut analysis. In some implementations, the well intervention tool 202 uses the machine learning models 212 to perform a behind-casing opportunity (BCO) analysis.

The well intervention tool 202 may run any combination of the production analysis, injection analysis, reservoir analysis, and petrophysical analysis in determining the candidate wells 10. For example, the well intervention tool 202 may run any combination of the DCA analysis, TW analysis, HI analysis, Chan plot analysis, productivity index analysis, VRR plot analysis, ABC plot analysis, hall plot analysis, well status analysis, numerical model analysis, RR analysis, kh analysis, water cut analysis, BCO analysis, reservoir analysis, and petrophysical analysis in determining the candidate wells 10.

The well intervention tool 202 uses the results of the different analyses performed along with the production history to probabilistically quantify post-intervention production rates for the candidate wells 10. In some implementations, the well intervention tool 202 estimates the deliverability of new zones that could be open in an existing well.

At 5, the workflow 300 includes multicriteria ranking of the candidate wells. The well intervention tool 202 ranks the candidate wells 10 based on a set of production and petrophysical KPIs. For example, top-ranking wells may be better candidates from a technical analysis perspective. In some implementations, the KPIs are identified by groups and whether the well is an inactive well or an active well.

One example group of KPIs for an inactive well is performance KPIs. Examples of performance KPIs for an inactive well include heterogeneity index (HI) and type well (TW). Another example group of KPIs for an inactive well includes ratio KPIs. Examples of ratio KPIs for an inactive well include water cut and gas to oil ratio (GOR). Another example group of KPIs for an inactive well includes potential KPIs. Examples of potential KPIs for an inactive well include remaining reserves (RR), RR/EUR (estimated ultimate recovery), gain, permeability times pay thickness (kh), areal trend (KH), and last oil rate (POST_Q).

One example group of KPIs for an active well is performance KPIs. Examples of performance KPIs for an active well include heterogeneity index (HI) and type well (TW). Another example group of KPIs for an active well includes ratio KPIs. Examples of ratios KPIs for an active well include water cut, areal water cut, and gas to oil ratio (GOR). Another example group of KPIs for an active well includes potential KPIs. Examples of potential KPIs for an active well include remaining reserves (RR), RR/EUR (estimated ultimate recovery), gain, permeability times pay thickness (kh), areal trend (KH), and last oil rate (POST_Q).

In some implementations, the well intervention tool 202 uses the machine learning models 212 to perform an analytic hierarchy process, a multicriteria ranking algorithm, to rank the candidate wells 10. The analytic hierarchy process provides a framework for representing and quantifying decision-making elements for a specific goal.

In some implementations, the analytic hierarchy process includes defining a decision hierarchy for the analytic hierarchy process. The machine learning models 212 creates a structured set of criteria and alternatives for ranking the candidate wells 10. For example, the machine learning models 212 define a goal, identify different criteria to use to achieve the goal, and identify different alternatives for each of the criteria. In some implementations, the different criteria and the alternatives are KPIs selected for the goal.

In some implementations, the analytic hierarchy process uses a series of pairwise comparisons and then synthesizes the results to capture both the qualitative and quantitative nature of the decision elements. The machine learning models 212 receive the pairwise comparisons for each of the criteria and alternatives (e.g., the KPIs selected) determined for the analytic hierarchy process. In some implementations, the user 204 compares each pair of elements (criteria/sub-criteria) at each level in the hierarchy and assigns a preference to the criteria and provides the preferences to the machine learning models 212. For example, the user 204 uses a 9-point scale to assign preferences (e.g., how much is attribute A is more preferred to attribute B or vise versa). The users 204 make a pairwise comparison for a range of attributes and indicate the priorities, and the priorities are provided to the machine learning models 212 to use in the analytic hierarchy process. The analytic hierarchy process can be customized to different user preferences through the pairwise comparisons.

In some implementations, the analytic hierarchy process calculates a relative priority of the criteria (e.g., the relative priority of the KPIs selected). The machine learning models 212 use an eigen value method to derive a priority (weights) vector for the criteria. For example, a positive reciprocal matrix of the assigned preferences is formed by the machine learning models 212. The machine learning models 212 may normalize the eigenvector to generate a normalized eigen vector. The machine learning models 212 may obtain the criteria weights from the normalized eigen vector.

In some implementations, the analytic hierarchy process performs a consistency check of the priorities indicated during the pairwise comparison. The machine learning models 212 perform a consistency check. An example equation that the machine learning models 212 use to define the consistency indices (CI) and consistency ratio (CR) of a user priority is illustrated in equation (1) below:

$$CR = ( \frac{{λ}_{max} - n}{n - 1} ) ( \frac{1}{RI} ) \qquad ( 1 )$$

where λₘₐₓ is the maximum eigenvalue of the pairwise comparison vector, n is the number of attributes and RI is the average of CI generated from randomly generated pairwise comparison matrices. When the CR is higher than 0.1, the machine learning models 212 determine that the priorities provided for the criteria are inconsistent. When the CR is less than 0.1, the machine learning models 212 determine that the priorities provided for the criteria are consistent.

In some implementations, the analytic hierarchy process aggregates the judgments. After adjusting the weights of the criteria (e.g., the KPIs) following the consistency check, the machine learning models 212 synthesizes the judgments to determine the overall rank of the candidate wells 10. For example, the machine learning models calculate a final ranking score for each candidate well 10 using the weights of the criteria (e.g., the KPIs). The candidate wells 10 are ranked using the final ranking score.

The analytic hierarchy process is integrated into the automated screening procedure of the workflow 300 to rank the candidate wells 10 for intervention opportunities according to user priorities. The analytic hierarchy process incorporates techniques to help evaluate the consistency in the weightings derived from the process, thereby reducing the bias in the final rankings, preserving objectivity, and maintaining repeatability in the complex decision-making process.

In some implementations, underperforming candidates with the highest post-intervention potential based on the production and reservoir KPIs are ranked as top intervention candidates by the well intervention tool 202 in response to performing the analytic hierarchy process on the candidate wells 10.

At 6, the workflow 300 includes performing constraint detection. The well intervention tool 202 determines one or more constraints in the candidate wells 10. In some implementations, the well intervention tool 202 uses the machine learning models 212 to perform the constraint detection in the candidate wells 10. For example, the machine learning models 212 use a decision-tree diagram to investigate the production issue (constraint) in a candidate well 10 based on the results of automated screening and KPIs. Example constraints include mechanical constraints, water production constraints, gas lift constraints, liquid loading constraints, sand production constraints, and well integrity constraints.

At 7, the workflow 300 includes generating workover recommendation. The well intervention tool 202 provides one or more recommendations 14 (FIG. 2) for the candidate wells 10. In some implementations, the well intervention tool 202 uses the machine learning models 212 to provide the recommendations 14. The recommendations 14 are suggestions to improve the production rate of the candidate wells 10. Example recommendations 14 may include zone changes, water shut-off, additional performance, BCO, gas lift valve changes, choke optimizations, stimulation, well cleaning, or using an artificial lift. The machine learning models 212 use the constraints and the screening results to generate the recommendations 14. For example, if the well rate is undermined because of high formation damage (screening result), but the well integrity (constraint) is also not good, the recommendation 14 generated by the machine learning model 212 may include a suggestion to ensure that the barriers are reinstated before performing an acidizing job.

At 8, the workflow 300 includes a success and economics analysis. In some implementations, the well intervention tool 202 uses the machine learning models 212 to perform a success and economics analysis of the candidate wells 10 and the recommendations 14. For economics analysis, a random forest model is used by the well intervention tool 202 with economic KPIs including gain, hydrocarbon price model, intervention and integrity cost, production sharing contract, etc. to perform the economic analysis of the candidate wells 10. The random forest model also estimates the cost and profits for the suggested intervention job (e.g., the recommendations 14). The well intervention tool 202 may use a Bayesian belief network (BBN) model to predict and quantify the chances of success for a suggested intervention job using historical intervention data such as workover success, cost, gain, etc.

At 9, the workflow 300 includes integrated simulations. The well intervention tool 202 runs an integrated simulation to validate the results from the machine learning models 212. For example, the well intervention tool 202 runs a mechanistic analysis to validate the results from the machine learning models 212. In some implementations, the well intervention tool 202 runs a predefined sensitivity analysis based on the suggested intervention job in the recommendations 14 using simulated well models.

At 10, the workflow 300 includes performing visual analytics of the analysis. The well intervention tool 202 performs visual analytics of the analysis performed. In some implementations, the well intervention tool 202 uses an opportunity register that is part of the output database and contains the results from executed statistical, mechanical, and economic analyses. The opportunity register allows engineers (e.g., the users 204) to perform detailed visual analytics at well and field levels using the user interface 16 of the device 206. The users 204 can select top intervention opportunities from multi-criteria ranking, validate the results, and schedule the workover job for tracking purposes.

At 11, the workflow 300 includes workover execution. The well intervention tool 202 receives a selection of a workover (e.g., a recommendation 14) that the user 204 selects to perform on the candidate well 10. For example, the validated intervention opportunity is executed in the field on the candidate well 10.

At 12, the workflow 300 includes receiving workover responses. The well intervention tool 202 receives the actual post-intervention gains, intervention cost, and intervention duration in response to the intervention opportunity being executed in the field. The post-intervention gains, intervention cost, and intervention duration are entered into the well intervention tool 202 as a feedback loop. The entered results tune the machine learning models 212 (e.g., a BBN model) to improve the future cost and success predictions of future recommendations 14.

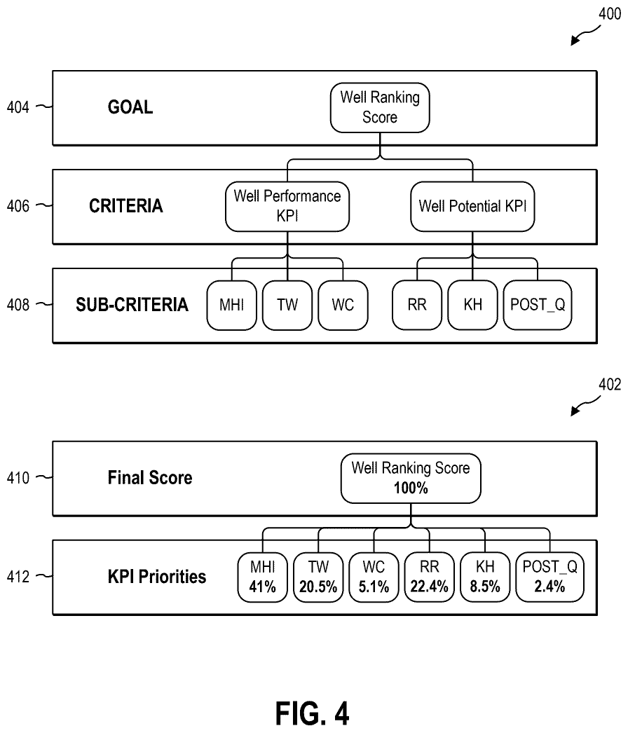

FIG. 4 illustrates an example analytic hierarchy process performed by the well intervention tool 202 (FIGS. 2 and 3) to automate the screening procedure to rank the candidate wells 10 (FIG. 2) for intervention according to the user priorities. In the illustrated example, performance KPI and potential KPI are the two categories that the key performance indicators (KPIs) fall under. The performance KPIs are heterogeneity index (MHI), type well (TW), and water cut (WC). The potential KPIs are remaining reserves (RR), areal trend (KH), and last oil rate (POST_Q).

The machine learning model 212 of the well intervention tool 202 automatically creates a decision hierarchy 400 for the analytic hierarchy process. The decision hierarchy 400 identifies the goal 404 as a well ranking score, the criteria 406 as the well performance KPI and the well potential KPI, and the sub-criteria 408 as the MHI KPI, the TW KPI, the WC KPI, the RR KPI, the KH KPI, and the POST_Q KPI.

The machine learning model 212 receives the pairwise comparisons of the criteria and the sub-criteria. For example, the user 204 provides the pairwise comparison of the criteria and the sub-criteria. The pairwise comparisons provide customization of the analytic hierarchy process to a preference of the user 204. The pairwise comparisons indicate a relative importance of the KPIs as compared to one another.

Table 1 provides an example of the pairwise comparison of the performance KPI and the potential KPI.

TABLE 1

| Criteria | Performance | Potential |
|---|---|---|
| Performance KPIs | 1 | ½ |
| Potential KPIs | 2 | 1 |

Table 2 provides an example of the pairwise comparison of performance KPIs received.

TABLE 2

| Sub-Criteria: | | | |
|---|---|---|---|
| Performance KPI | MHI | TW | WC |
| MHI | 1 | 2 | 8 |
| TW | ½ | 1 | 4 |
| WC | ⅛ | ¼ | 1 |

Table 3 provides an example of the pairwise comparison of potential KPIs received.

TABLE 3

| Sub-Criteria: | | | |
|---|---|---|---|
| Potential KPI | RR | KH | Post_Q |
| RR | 1 | 3 | 8 |
| KH | ⅓ | 1 | 4 |
| Post_Q | ⅛ | ¼ | 1 |

The machine learning model 212 calculates weights for each criterion (performance and potential KPI) and sub-criteria (MHI, TW, WC, RR, KH, Post_Q) using the pairwise comparison received. The decision hierarchy 402 illustrates the weights calculated by the machine learning model 212. The weight percentage of nodes under a node in any level add to 100%. The global priority for each KPI is determined by the machine learning model 212. The machine learning model assigns an overall weight to each of the final score 410 and the KPI priorities 412. For example, the machine learning model 212 assigns a 100% weight to the well ranking score, 41% weight to MHI, 20.5% weight to TW, 5.1% weight to WC, 22.4% weight to RR, 8.5% weight to KH, and 2.4% weight to Post_Q.

In some implementations, the machine learning model 212 normalizes the KPI values in the range (0, 1). The machine learning model 212 calculates a final ranking score 410 for each well of the candidate wells 10 and the candidate wells 10 are ranked using the final ranking score 410. An example equation the machine learning model 212 uses for the final ranking score 410 is illustrated below in equation (2).

$$Final Ranking Score = ( MHI value * weight of MHI KPI ) + ( TW Value * weight of TW KPI ) + ( WC value * weight of WC KPI ) + ( RR value * weight of RR KPI ) + ( KH value * weight of KH KPI ) + ( Post\_Q value * weight of Post\_Q KPI ) \qquad ( 2 )$$

The machine learning model 212 automatically ranks the candidate wells 10 according to user priorities using the analytic hierarchy process. In some implementations, top-ranking candidate wells 10 may be better candidates from a technical analysis perspective.

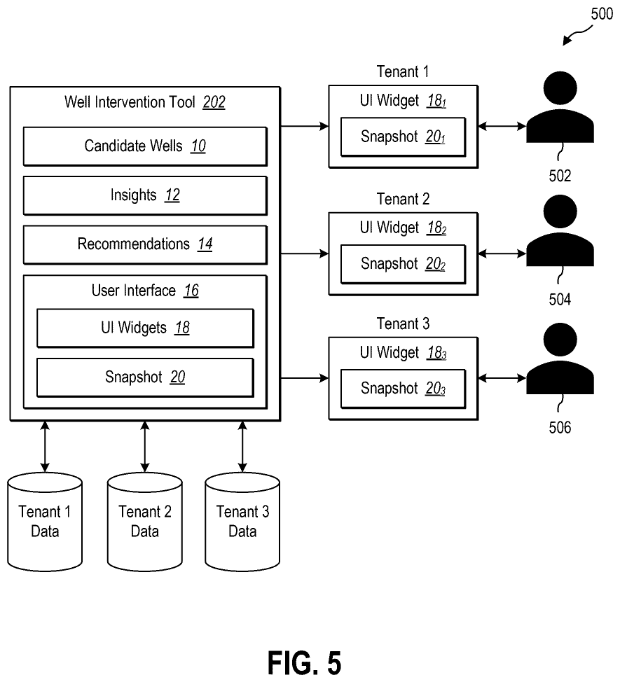

FIG. 5 illustrates an example environment 500 for a multi-tenant well intervention tool 202. In some implementations, the well intervention tool 202 is a cloud-hosted multi-tenant application that uses a shared cloud infrastructure to provide access to the well intervention tool 202 to multiple users 502, 504, 506. A tenant is a unit of physically partitioned data. A tenant may have multiple hierarchies. A hierarchy is a structure of logical connections between different oilfield entities. A hierarchy is used to organize entities in a way that reflects physical or business structures. A hierarchy structure is defined by the connections between entity types. The structure defines the valid relationships between entities of different entity types. An entity represents a thing, either real or virtual. Entities are uniquely identifiable. Property is a data attribute associated with an entity. A property may be measured, calculated, or derived. Properties may be variety of data types.

A dataset is a logical named group of properties that is associated with a dataset class. Datasets define a view on the data. A dataset class defines common characteristics of a dataset. A dataset class determines how the data is stored along with constraints and data relationships. One example dataset class includes an event for an entity. Events for an entity have a start and end date. Another example dataset class includes an attribute with attribute data for an entity. All attributes for an entity are stored as properties in a single record. Another example dataset class includes versioned attributes for an entity that allows for attributes to be versioned over time. Another example dataset class includes a table that stores multiple records for an entity grouped as a named table. There may be many tables for an entity. Another example dataset class includes versioned tables for an entity that allows the tables to be versioned over time. Another example dataset includes a timeseries for an entity that stores timeseries data for an entity grouped as a named timeseries table. There may be many tables for an entity. Another example dataset includes timeseries versioned for an entity allows the timeseries data to be versioned over time.

The multi-tenant application supports customization at all levels (e.g., data, workflows (e.g., the workflow 300 (FIG. 3), and the user interface 16. Data is flexible hierarchies and entity types, customizable data properties, and datasets. The workflows read input data and save results with flexible data flows, enabling collaboration between data analysts, domain experts and data scientists. The user interface 16 includes customizable forms, pages, and UI widgets 18.

The well intervention tool 202 provides an ability to end users 502, 504, 506 in multiple tenants to customize and configure different UI widgets 18 as per their use case. In some implementations, the user interface 16 includes four areas, pages, sections, groups, UI widgets 18. A page is a structured representation of a page in the user interface 16. A section is a structure that describes a region within a page. A UI widget 18 is a structure that describes a visual element. Examples of a UI widget 18 include a tile, details, chart, list, group, custom form, and grid. Tags are a labeling structure that marks UI widgets 18 and pages. The pages, sections, and group areas of the user interface 16 help organize the page layout, while the UI widgets 18 are the content blocks showing the tenant-specific snapshot 20 of data stored in the database. In some implementations, the UI widgets 18 show the snapshot 20 of data as semi-structured JSON records generated by a multi-tenant batch ingestion service. The JSON records may hold data for multiple datasets categorized under dataset classes.

The snapshots 20 are used to capture and manage different versions or states of a table at specific points in time. Snapshots 20 enable, data auditing, schema evolution, and query consistency over time. Each snapshot 20 represents a specific version of the data table. A snapshot 20 freezes the state of the table when the snapshot 20 is taken making it possible to maintain a historical record of changes to the table over time. Snapshots 20 allow querying of the data in a table as it existed at the time a specific snapshot was taken. Snapshots 20 allows for historical analysis, auditing, and debugging of data without affecting the current state of the table. Snapshots 20 are not modified once created ensuring the integrity and consistency of historical data. Any changes to the table are reflected in new snapshots. Using snapshots 20 provides consistent reads when querying data. The queries see a consistent view of the data as it existed at the time of the snapshot, even if changes to the table are ongoing.

For example, the well intervention tool 202 outputs a UI widget 18₁ with a snapshot 20₁ for the tenant 1 using the tenant 1 data. The well intervention tool 202 outputs a UI widget 18₂ with a snapshot 202 for the tenant 2 using the tenant 2 data. The well intervention tool 202 outputs a UI widget 183 with a snapshot 203 for the tenant 3 using the tenant 3 data.

In some implementations, the well intervention tool 202 links different data sources to the UI widgets 18 via property codes in a master catalog using application programming interfaces (APIs). Each of the UI widgets 18 can then be configured in the individual tenants by adding, removing, or swapping mapped property codes; as well as changing the formatting of the UI widget 18 itself. The changes can be performed before or after enabling the UI widgets 18 on the user's user interface 16, without the need to redeploy the application each time a change is made.

In some implementations, the well intervention tool 202 works with a combination of a set of plugins (hosted in a machine learning platform) and a cloud-hosted multi-tenant batch ingestion service. A plugin is a computer program or script.

The plugin reads data from the different data sources (e.g., staged tables in the machine learning platform or external cloud-hosted databases). The plugin generates an epoch timestamp. The plugin creates a staging table (with the generated epoch timestamp in step 2 as a suffix) in sandbox database tenant-specific schema. The plugin calls a master catalog API to validate property codes helping to make sure that ingested Json records have valid fields the admin can use to configure UI widgets 18. The plugin calls an HTTP API to start asynchronous batch ingestion for specific datasets (e.g., versioned table, versioned attribute, versioned time series, events, entities, and hierarchies). In some implementations, different plugins are used. For example, an event plugin is used, and an entities/hierarchy plugin is used.

The plugins help to configure and read datasets from different data sources e.g., databases, API, or cloud data foundation systems, stage datasets in tenant sandbox database, and start batch jobs using REST HTTP API. The batch job service resolves tenant names using the provided credential secret, reads stage dataset rows in batches, resolves entity ids from entity names and types, generates unique batch ids for snapshot versions, transforms datasets rows to JSON records, and updates tenant-specific dataset tables in tenant schema. The batch job also creates database views from datasets table. The UI widget API uses datasets view to bind widgets with datasets and fetches view data from a backend API.

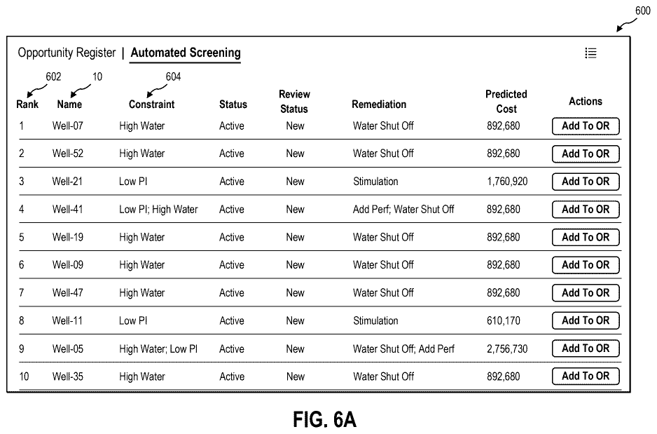

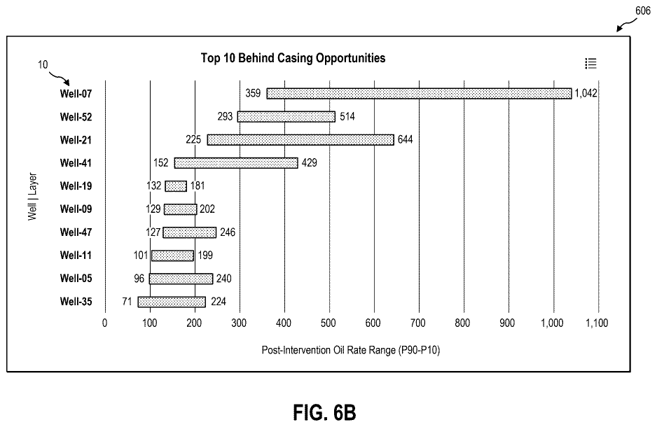

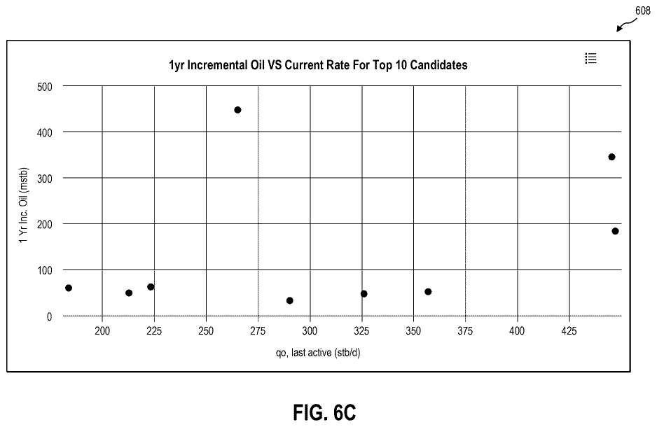

FIG. 6A illustrates an example graphical user interface 600 of an insight 12 (FIGS. 2 and 5) presented on the user interface 16 (FIGS. 2 and 5). For example, the insight 12 is an automated screening summary table generated by the well intervention tool 202 (FIGS. 2 and 5) in response to performing the workflow 300 (FIG. 3).

The screening summary table shows top candidate wells (e.g., the candidate wells 10) identified in the intervention opportunity manager screening workflow in the workflow 300 and the ranks 602 identified by the workflow 300. The screening summary table displays the main constraint 604 in the production well, a production status, a review status, an actionable remediation suggested by the well intervention tool 202, associated predicted costs of the remediation activity, last oil rate while the well was active, predicted post-intervention oil rate, 1 and 3 year incremental oil production volumes, and incremental 1 and 3 year net present value of the opportunity.

FIG. 6B illustrates an example graphical user interface 606 of an insight 12 (FIGS. 2 and 5) presented on the user interface 16 (FIGS. 2 and 5). For example, the insight 12 is a graph of behind screening opportunities generated by the well intervention tool 202 (FIGS. 2 and 5) in response to performing the workflow 300 (FIG. 3). This bar plots the top ten candidate wells 10 where there is an additional reservoir pay zone with best oil potential rates. The bar plot shows the probabilistic range of the predicted oil rate, P10 and P90 respectively.

FIG. 6C illustrates an example graphical user interface 608 with an insight 12 (FIGS. 2 and 5) presented on the user interface 16 (FIGS. 2 and 5). For example, the insight 12 is a scatter plot of incremental oil versus a current rate generated by the well intervention tool 202 (FIGS. 2 and 5) in response to performing the workflow 300 (FIG. 3). The scatter plot shows the relative values of the top ten candidate wells 10. The scatter plot compares the current oil rate with the incremental oil volumes gained by the suggested remediation by the system and may be used by the users 204, 502, 504, 506 (FIGS. 2 and 5) in further selecting the best candidates.

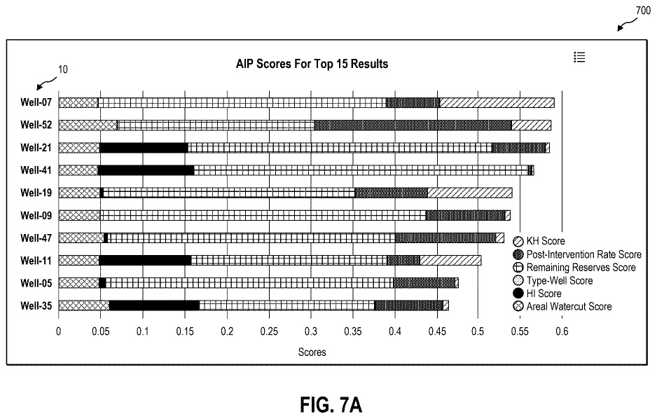

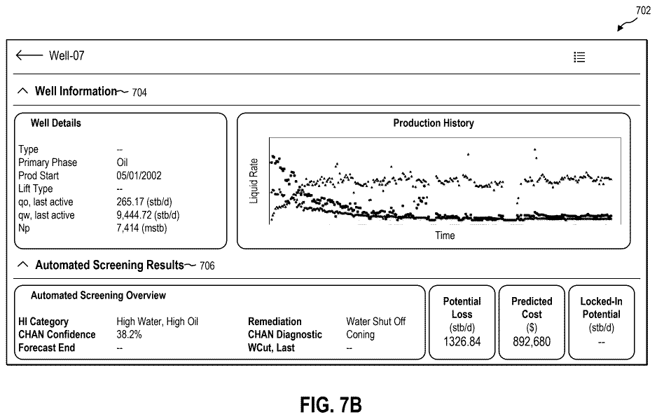

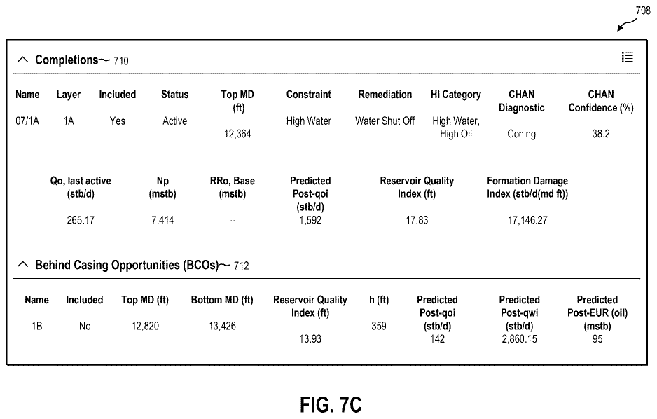

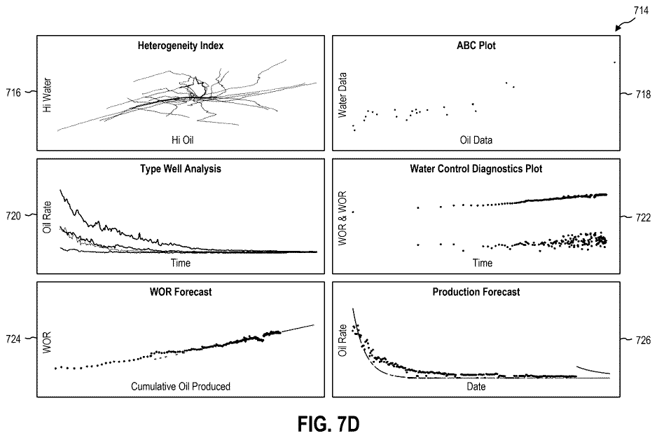

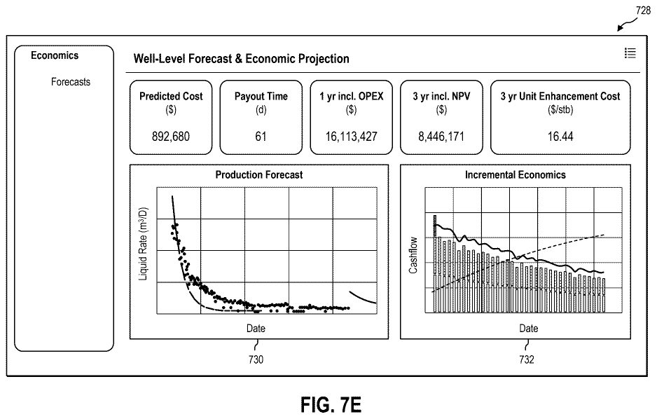

FIG. 7A illustrates an example graphical user interface 700 of a UI widget 18 (FIGS. 2 and 5) presented on the user interface 16 (FIGS. 2 and 5). For example, the UI widget 18 is an AHP opportunity widget automatically generated by the well intervention tool 202 (FIGS. 2 and 5) in response to performing the workflow 300 (FIG. 3). The UI widget 18 compares the top candidate wells 10 based on a multi-criteria decision-making process (the analytic hierarchy process used by the well intervention tool 202).

FIG. 7B illustrates an example graphical user interface of a UI widget 18 (FIGS. 2 and 5) presented on the user interface 16 (FIGS. 2 and 5). For example, the UI widget 18 is a well details page automatically generated by the well intervention tool 202 (FIGS. 2 and 5) in response to performing the workflow 300 (FIG. 3). Upon clicking on a particular well in the automated screening results table in the graphical user interface 700, the user 204, 502, 504, 506 (FIGS. 2 and 5) is taken to the well details page that provides further diagnostic and information to help the user with the decision to remediate a well.

The well details page includes a well information section 704. Within the well information section 704, well details are provided. The well information section 704 includes a production history timeseries plot showing oil, water, and gas historical production rates for the well.

The well details page includes an automated screening results section 706. The automated screening results section 706 includes details from the intervention screening workflow (the workflow 300), including the heterogeneity index (HI) category identified for the well, Chan model confidence, expected end of the oil forecast, suggested remediation, Chan model diagnostics, last water cut of the well, percentage of reserves remaining in the well (RR/EUR), and the net oil pay thickness in the well (kh). The six tiles on the right side of the automated screening results section 706 show the quantitative parameters of the screening process including potential loss (estimated oil rate that the active zones are underproducing), locked in potential (estimated oil rates in the inactive zones in the well), predicted post-qoi (predicted post-intervention oil rate of the well), predicted cost of the remediation, 3 year incremental net present value of the opportunities in the well, and 1 year incremental oil volumes that could be achieved by performing the suggested remediation.

FIG. 7C illustrates an example graphical user interface 708 of a UI widget 18 (FIGS. 2 and 5) presented on the user interface 16 (FIGS. 2 and 5). For example, the UI widget 18 with tabular results for the individual zones in the candidate wells 10 automatically generated by the well intervention tool 202 (FIGS. 2 and 5) in response to performing the workflow 300 (FIG. 3). The completions table 710 includes a list of well completions. Completions represent the perforations in the well. The completion table 710 includes diagnostic results from the well completion.

The behind casing opportunities (BCOs) table 712 includes behind casing opportunities (BCOs). BCOs represent the unperforated layers in the candidate well. In the illustrated example, the well is perforated in the layer 1A, and has no perforations in the layer 1B. The results of the analysis in the unperforated layer are shown in the BCOs table 712.

FIG. 7D illustrates an example graphical user interface of a UI widget 18 (FIGS. 2 and 5) presented on the user interface 16 (FIGS. 2 and 5). For example, the UI widget 18 with visualizations is automatically generated by the well intervention tool 202 (FIGS. 2 and 5) in response to performing the workflow 300 (FIG. 3). In the illustrated example, the visualizations represent the diagnostic plots from the well completion, 07/1A (FIG. 7C).

The heterogeneity index visualization plot 716 utilizes the historical data to diagnose wells. In some implementations, the heterogeneity index visualization plot 716 is used to compare the production behavior of a well completion with that of other well completions in the same oil reservoir. The path of the candidate well completion is highlighted in a color (e.g., a pink color) so the users 204, 502, 504, 506 (FIGS. 2 and 5) can easily compare the path with other wells in the plot. The well intervention tool 202 uses the screening workflow (the workflow 300) to interpret the heterogeneity index visualization plot 716 automatically.

In some implementations, the ABC plot 718 is used to compare the relative decline of oil and water production of a well completion with that of other well completions in the same reservoirs. Wells that are rapidly declining are highlighted through this diagnostic plot. The target well completion is highlighted in a color (e.g., a pink color) in the ABC plot 718.

In some implementations, the type well analysis plot 720 is used to compare the production profile of a well completion with production profiles of other well completions in the reservoir.

In some implementations, the water control diagnostics plot 722 is based on interpretation of water-oil ratio and the derivative of a well completion. The water control diagnostics plot 722 is used to identify the root cause of high water production in an oil well.

In some implementations, the WOR forecast plot 724 is used to forecast the water production in a well completion. The WOR forecast plot 724 assists the users 204, 502, 504, 506 (FIGS. 2 and 5) of the well intervention tool 202 in planning activities in the well.

In some implementations, the production forecast plot 726 shows the production decline trend and expected oil rates in the near future. Based on the recommendations 14 (FIGS. 2 and 5) generated by the automated screening workflow (the workflow 300), a post-intervention forecast is also generated and added to the production forecast plot 726 to assist the users in decision making.

FIG. 7E illustrates an example graphical user interface of a UI widget 18 (FIGS. 2 and 5) presented on the user interface 16 (FIGS. 2 and 5). For example, the UI widget 18 with well level production forecasts and economic projections is automatically generated by the well intervention tool 202 (FIGS. 2 and 5) in response to performing the workflow 300 (FIG. 3). A well may have more than one completion or perforations, therefore it may be necessary to roll up the production forecasts at well level. The UI widget 18 provides a visualization of the economic analysis performed on the candidate well including predicted cost, pay out time, 1-year incremental operating costs (OPEX), 3-year incremental net present value (NPV) of the remediation suggested, and 3-year unit enhancement cost ($/stb). The UI widget 18 also shows a production forecast 730 at the well level, which has both the base-case forecast and the post-intervention forecast (P50 case). The UI widget 18 also shows a visualization of the incremental economics impact 732 on the candidate well, showing cash flows in the near future via revenue, operating costs, taxes, CAPEX, and net present value in a timeseries.

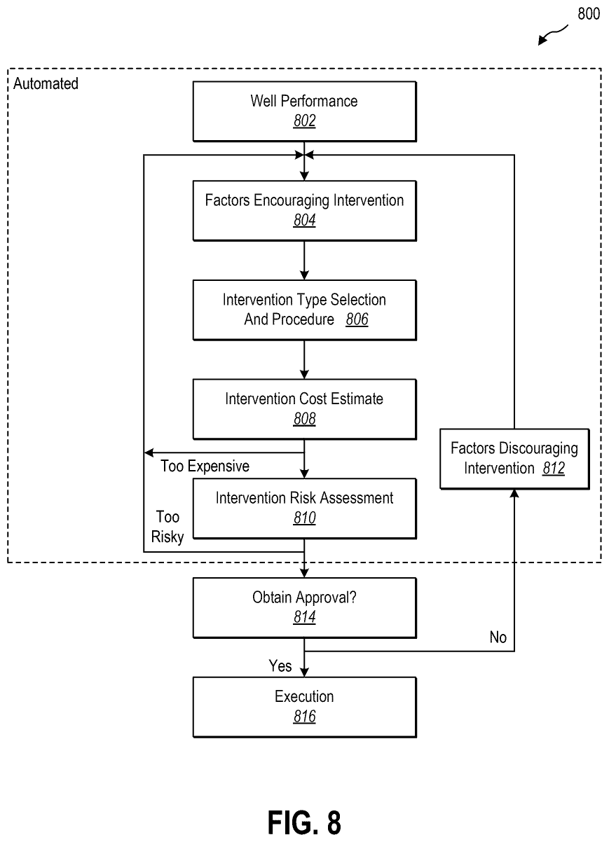

FIG. 8 illustrates an example method 800 for automatically identifying an intervention job. The actions of the method 800 are discussed below in reference to FIGS. 1-7. In some implementations, the well intervention tool 202 performs the actions of 802, 804, 806, 808, 810, 812 automating the process for identifying a well intervention job. Existing solutions perform the actions illustrated in the method 800 with a manual, repetitive process, which is highly time consuming.

At 802, the method 800 includes obtaining well performance data. The well intervention tool 202 obtains the well performance data. At 804, the method 800 includes identifying factors encouraging intervention. The well intervention tool 202 identifies factors in the well performance data that encourages intervention.

At 806, the method 800 includes selecting an intervention type and procedure. The well intervention tool 202 selects an intervention type and procedure for candidate wells 10 in response to the factors in the well performance data encouraging intervention. At 808, the method 800 includes determining an intervention cost estimate. The well intervention tool 202 determines an intervention cost estimate for the selected intervention type and procedure for the candidate wells 10. In some implementations, the method 800 returns to 806 and another intervention type is selected in response to the well intervention tool 202 determining that the intervention cost is too expensive (e.g., exceeds a cost budgeted for the intervention).

At 810, the method 800 includes performing an intervention risk assessment. The well intervention tool 202 performs an intervention risk assessment on the selected intervention type and procedure for the candidate wells 10. In some implementations, the method 800 returns to 806 and another intervention type is selected in response to the well intervention tool 202 determining that the intervention risk is high (e.g., above a risk threshold).

At 812, the method 800 obtains approval for the selected intervention type and procedure. The well intervention tool 202 sends the selected intervention type and procedure for approval in response to determining the intervention risk is within an acceptable limit (e.g., below a risk threshold). At 814, the method 800 executes the selected intervention type and the procedure. The well intervention tool 202 helps the user 204 coordinate the selected intervention type and the procedure in response to the well intervention tool 202 receiving the approval for the selected intervention type and procedure for the candidate wells 10.

At 812, the method 800 may receive factors discouraging intervention and returns to 806 to select another intervention type in response to not receiving approval for the selected intervention type and procedure. The well intervention tool 202 receives the factors discouraging intervention and uses the factors to update the selection of the intervention type and procedure. The well intervention tool 202 uses the feedback received from the factors discouraging intervention, levels of risk, and costs of the intervention to improve future selections of interventions and procedures.

The method 800 automates the process for selecting a workover intervention job. The method 800 leverages data from the workover history and customizable business logic to perform economic analyses and predict post-workover production, success probability, and probability. The method 800 reduces cognitive bias that occurs in a manual process and reduces hundreds of hours of manual work to a few minutes of automated computation.

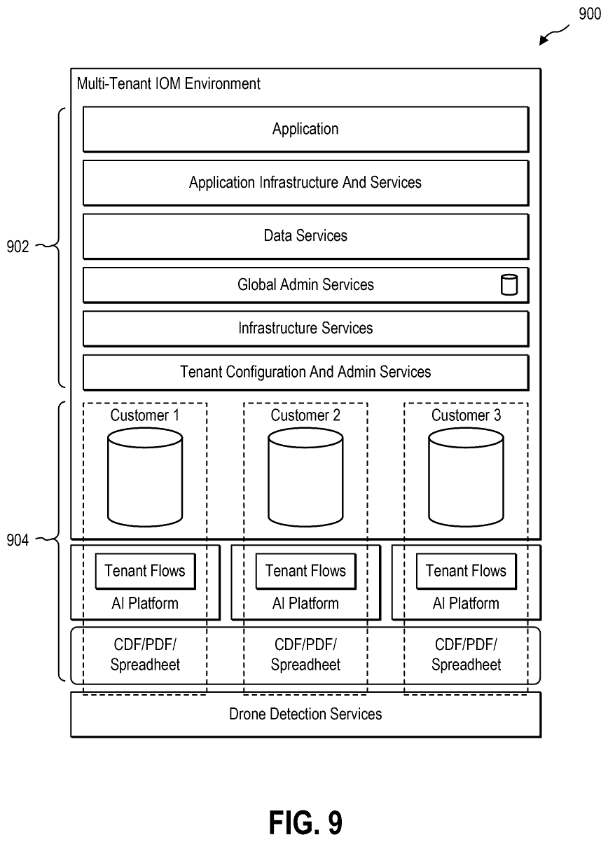

FIG. 9 illustrates an example environment 900 for a multi-tenant well intervention tool. In some implementations, the well intervention tool 202 is a cloud-hosted multi-tenant application that uses a shared cloud infrastructure to provide access to the well intervention tool 202 to multiple tenants.

The environment 900 includes shared services and infrastructure 902 and tenant specific infrastructure 904. The shared services and infrastructure 902 include the well intervention tool 202 accessible by the different customers of the tenants and the infrastructure and services to support the well intervention tool 202. The shared services and infrastructure 902 also include the data services and global administration services. The shared services and infrastructure 902 also include tenant configuration and administration services.

The tenant specific infrastructure 904 includes the data specific to a tenant and the workflows for the tenant. In some implementations, the data and the workflows are customized to each tenant. The tenant specific infrastructure 904 also includes data sources that each tenant can access. In some implementations, the tenants use the same instance of a machine learning platform.

The environment 900 leverages the processing capabilities, memory capabilities, connectivity, speed, etc., that such cloud computing environments offer in order to facilitate the features and functionalities described herein.

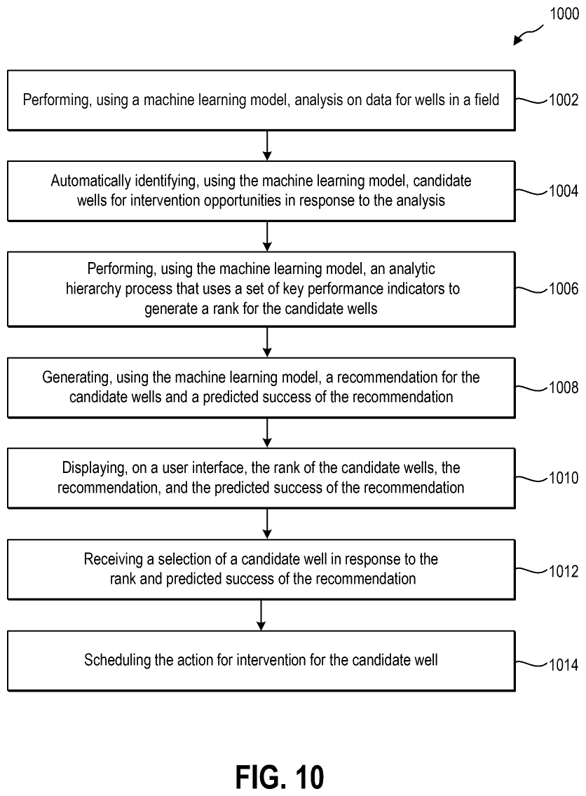

FIG. 10 illustrates an example method 1000 for automatically identifying candidate wells for intervention opportunities. The actions of the method 1000 are discussed below in reference to FIGS. 1-7.

At 1002, the method 1000 includes performing, using a machine learning model, analysis on data for wells in a field. The well intervention tool 202 uses a machine learning model 212 to perform analysis on data for wells in a field. In some implementations, the data is multidisciplinary data obtained from different data sources 210 and is consolidated into a single database for use by the machine learning model 212.

In some implementations, the analysis includes any combination of the one or more of a decline curve (DCA) analysis, a type well (TW) analysis, a heterogeneity index (HI) analysis, Chan plot analysis, productivity index analysis, a voidage replacement ratio (VRR) plot analysis, an after-before-compact (ABC) plot analysis, a hall plot analysis, a well status analysis, a numerical model analysis, a remaining reservoir (RR) analysis, a permeability times pay thickness (kh) analysis, water cut analysis, behind-casing-opportunity (BCO) analysis, reservoir analysis, and petrophysical analysis.

At 1004, the method 1000 includes automatically identifying, using the machine learning model, candidate wells for intervention opportunities in response to the analysis. The machine learning models 212 automatically identifies the candidate wells 10 for intervention opportunities in response to the analysis. In some implementations, the machine learning model 212 performs a plurality of petroleum engineering analyses on the data to generate a gain estimation of production for each candidate well 10.

At 1006, the method 1000 includes performing, using the machine learning model, an analytic hierarchy process that uses a set of key performance indicators to generate a rank for the candidate wells. The machine learning model 212 performs an analytic hierarchy process that uses a set of key performance indicators to generate a rank for the candidate wells 10. In some implementations, the key performance indicators include performance key performance indicators, ratio key performance indicators, and potential key performance indicators.

In some implementations, the analytic hierarchy process further includes: defining a decision hierarchy of key performance indicators to use in the ranking; receiving a priority for each key performance indicator in response to a pairwise comparison of the key performance indicators; calculating a weight for each key performance indicator using the priority; performing a consistency check of the weights for each key performance indicator; calculating a final ranking score for the candidate wells using the weights for each key performance indicator; and using the final ranking score to rank the candidate wells.

At 1008, the method 1000 includes generating, using the machine learning model, a recommendation for the candidate wells and a predicted success of the recommendation. The machine learning model 212 generates a recommendation 14 for the candidate wells 10 and a predicted success of the recommendation 14. In some implementations, the recommendation 14 includes an action for intervention. In some implementations, the machine learning model 212 identifies constraints of the candidate wells 10 and generates the action in the recommendation in response to the constraints. For example, the constraints identify a cause of a production issue in the candidate wells 10.

At 1010, the method 1000 includes displaying, on a user interface, the rank of the candidate wells, the recommendation, and the predicted success of the recommendation. The well intervention tool 202 displays on a user interface 16 the candidate wells 10, the rank of the candidate wells 10, the recommendation 14, and a predicted success of the recommendation 14. In some implementations, an insight with a snapshot 20 of the data for the candidate wells 10 is displayed on the user interface 16. The snapshot 20 captures the data for a specific time frame. In some implementations, a UI widget 18 with an insight for the candidate wells 10 is displayed on the user interface 16.

At 1012, the method 1000 includes receiving a selection of a candidate well in response to the rank and predicted success of the recommendation. The well intervention tool 202 receives a selection of the candidate well 10 in response to the rank and the predicted success of the recommendation. For example, a user selects the candidate well 10. Another example includes the well intervention tool 202 automatically selecting the candidate well 10.

At 1014, the method 1000 includes scheduling the action for intervention for the candidate well. The well intervention tool 202 schedules the action for intervention for the candidate well. For example, the well intervention tool 202 ensures the materials and/or tools are available at the field for the action. In some implementations, the action is a well-maintenance service to address a production issue in the candidate well 10 to provide a production rate of the candidate well 10 for a longer duration. Example actions include stimulation, zonal isolation, wellbore cleanout, reinstatement, water shut off, hydraulic fracturing, re-perforation, and zone change operations.

In some implementations, the well intervention tool 202 receives intervention gains, intervention costs, and a duration of the intervention in response to performing the action on the candidate well 10. The well intervention tool 202 provides feedback to the machine learning model 212 to use the intervention gains, the intervention costs, and the duration of the intervention in improving future recommendations and future predictions of success for the candidate wells 10.

In some implementations, the well intervention tool 202 is used by a multi-tenant system with a plurality of tenants. The well intervention tool 202 may partition the data for each tenant to prevent unauthorized access to the data; customize the analysis performed on the data for each tenant; and customize the user interface displayed for each tenant. In some implementations, the well intervention tool 202 displays a first user interface for a first tenant with a first snapshot of the data of the first tenant; displays a second user interface for a second tenant with a second snapshot of the data of the second tenant; and displays a third user interface for a third tenant with a third snapshot of the data of the third tenant.

The method 1000 automates the identification of candidate wells 10 for intervention opportunities and providing recommendations for extending the production of the candidate wells 10.

Turning now to FIG. 11, this figure illustrates certain components that may be included within a computer system 1100. One or more computer systems 1100 may be used to implement the various devices, components, and systems described herein.

The computer system 1100 includes a processor 1101. The processor 1101 may be a general-purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 1101 may be referred to as a central processing unit (CPU). Although just a single processor 1101 is shown in the computer system 1100 of FIG. 11, in an alternative configuration, a combination of processors (e.g., an ARM and DSP) could be used.

The computer system 1100 also includes memory 1103 in electronic communication with the processor 1101. The memory 1103 may include computer-readable storage media and can be any available media that can be accessed by a general purpose or special purpose computer system. Computer-readable media that store computer-executable instructions are non-transitory computer-readable media (device). Computer-readable media that carry computer-executable instructions are transmission media. Thus, by way of example and not limitations, implementation of the present disclosure can comprise at least two distinctly different kinds of computer-readable media: non-transitory computer-readable media (devices) and transmission media.

Both non-transitory computer-readable media (devices) and transmission media may be used temporarily to store or carry software instructions in the form of computer readable program code that allows performance of implementations of the present disclosure. Non-transitory computer-readable media may further be used to persistently or permanently store such software instructions. Examples of non-transitory computer-readable storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored or in software, hardware, firmware, or combinations thereof.

Instructions 1105 and data 1107 may be stored in the memory 1103. The instructions 1105 may be executable by the processor 1101 to implement some or all of the functionality disclosed herein. Executing the instructions 1105 may involve the use of the data 1107 that is stored in the memory 1103. Any of the various examples of modules and components described herein may be implemented, partially or wholly, as instructions 1105 stored in memory 1103 and executed by the processor 1101. Any of the various examples of data described herein may be among the data 1107 that is stored in memory 1103 and used during execution of the instructions 1105 by the processor 1101.

A computer system 1100 may also include one or more communication interfaces 1109 for communicating with other electronic devices. The communication interface(s) 1109 may be based on wired communication technology, wireless communication technology, or both. Some examples of communication interfaces 1109 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

The communication interfaces 1109 may connect the computer system 1100 to a network. A “network” or “communications network” may generally be defined as one or more data links that enable the transport of electronic data between computer systems and/or modules, engines, or other electronic devices, or combinations thereof. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instruction or data structures and which can be accessed by a general purpose or special purpose computer.

A computer system 1100 may also include one or more input devices 1111 and one or more output devices 1113. Some examples of input devices 1111 include a keyboard, mouse, microphone, remote control device, button, joystick, trackball, touchpad, and lightpen. Some examples of output devices 1113 include a speaker and a printer. One specific type of output device that is typically included in a computer system 1100 is a display device 1115. Display devices 1115 used with implementations disclosed herein may utilize any suitable image projection technology, such as liquid crystal display (LCD), light-emitting diode (LED), gas plasma, electroluminescence, or the like. A display controller 1117 may also be provided, for converting data 1107 stored in the memory 1103 into one or more of text, graphics, or moving images (as appropriate) shown on the display device 1115.

The various components of the computer system 1100 may be coupled together by one or more buses, which may include one or more of a power bus, a control signal bus, a status signal bus, a data bus, other similar components, or combinations thereof. For the sake of clarity, the various buses are illustrated in FIG. 11 as a bus system 1119.

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a classification model, a clustering model, a regression model, a language model, an object detection model, a probabilistic graphical model) that can be tuned (e.g., trained) based on training input to approximate unknown functions. For example, a machine learning model may refer to a neural network (e.g., a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Further, upon reaching various computer system components, program code in the form of computer-executable instructions or data structures can be transferred automatically or manually from transmission media to non-transitory computer-readable storage media (or vice versa). For example, computer executable instructions or data structures received over a network or data link can be buffered in memory (e.g., RAM) within a network interface module (NIC), and then eventually transferred to computer system RAM and/or to less volatile non-transitory computer-readable storage media at a computer system. Thus, it should be understood that non-transitory computer-readable storage media can be included in computer system components that also (or even primarily) utilize transmission media.

### INDUSTRIAL APPLICABILITY

The following description from ¶¶ [0020]-[0161] includes various implementations that, where feasible, may be combined in any permutation. For example, the implementation of ¶¶ [0020]-[0161] may be combined with any or all implementations of the following paragraphs. Implementations that describe acts of a method may be combined with implementations that describe, for example, systems and/or devices. Any permutation of the following paragraphs is considered to be hereby disclosed for the purposes of providing “unambiguously derivable support” for any claim amendment based on the following paragraphs. Furthermore, the following paragraphs provide support such that any combination of the following paragraphs would not create an “intermediate generalization.”

In some implementations, a method includes performing, using a machine learning model, analysis on data for wells in a field. The method includes automatically identifying, using the machine learning model, candidate wells for intervention opportunities in response to the analysis. The method includes performing, using the machine learning model, an analytic hierarchy process that uses a set of key performance indicators to generate a rank for the candidate wells. The method includes generating, using the machine learning model, a recommendation for the candidate wells and a predicted success of the recommendation, wherein the recommendation includes an action for intervention. The method includes displaying, on a user interface, the rank of the candidate wells, the recommendation, and the predicted success of the recommendation. The method includes receiving a selection of a candidate well in response to the rank and predicted success of the recommendation. The method includes scheduling the action for intervention for the candidate well.

In some implementations, the method includes the machine learning model performing a plurality of petroleum engineering analysis on the data to generate a gain estimation of production for each candidate well.

In some implementations, the method includes the analysis including one or more of a decline curve (DCA) analysis, a type well (TW) analysis, a heterogeneity index (HI) analysis, Chan plot analysis, productivity index analysis, a voidage replacement ratio (VRR) plot analysis, an after-before-compact (ABC) plot analysis, a hall plot analysis, a well status analysis a remaining reservoir (RR) analysis, a permeability times pay thickness (kh) analysis, water cut analysis, behind-casing-opportunity (BCO) analysis, reservoir analysis, and petrophysical analysis.

In some implementations, the method includes the analytic hierarchy process further including: defining a decision hierarchy of key performance indicators to use in the ranking; receiving a priority for each key performance indicator in response to a pairwise comparison of the key performance indicators; calculating a weight for each key performance indicator using the priority; performing a consistency check of the weights for each key performance indicator; calculating a final ranking score for the candidate wells using the weights for each key performance indicator; and using the final ranking score to rank of the candidate wells.

In some implementations, the method includes the key performance indicators include performance key performance indicators, ratio key performance indicators, and potential key performance indicators.

In some implementations, the method includes identifying, using the machine learning model, constraints of the candidate wells, wherein the constraints identify a cause of a production issue in the candidate wells; and generating, using the machine learning model, the action in the recommendations in response to the constraints.

In some implementations, the method includes receiving intervention gains, intervention costs, and a duration of the intervention in response to performing the action on the candidate well; and providing feedback to the machine learning model to use the intervention gains, the intervention costs, and the duration of the intervention in improving future recommendations and future predictions of success for the candidate wells.

In some implementations, the method includes the data is multidisciplinary data obtained from different data sources and is consolidated into a single database for use by the machine learning model.

In some implementations, the method includes displaying, on the user interface, an insight with a snapshot of the data for the candidate wells, wherein the snapshot captures the data for a specific time frame.

In some implementations, the method includes the action is a well-maintenance service to address a production issue in the candidate well to provide a production rate of the candidate well for a longer duration.

In some implementations, the method includes displaying, on the user interface, a user interface widget with an insight for the candidate wells.

In some implementations, the method includes is a multi-tenant system with a plurality of tenants; partitioning the data for each tenant to prevent unauthorized access to the data; customizing the analysis performed on the data for each tenant; and customizing the user interface displayed for each tenant.

In some implementations, the method includes displaying a first user interface for a first tenant with a first snapshot of the data of the first tenant; displaying a second user interface for a second tenant with a second snapshot of the data of the second tenant; and displaying a third user interface for a third tenant with a third snapshot of the data of the third tenant.

In some implementations, the system includes a memory to store data and instructions; and a processor operable to communicate with the memory, wherein the processor is operable to: perform, using a machine learning model, analysis on data for wells in a field; automatically identify, using the machine learning model, candidate wells for intervention opportunities in response to the analysis; perform, using the machine learning model, an analytic hierarchy process that uses a set of key performance indicators to generate a rank for the candidate wells; generate, using the machine learning model, a recommendation for the candidate wells and a predicted success of the recommendation, wherein the recommendation includes an action for intervention; display, on a user interface, the rank of the candidate wells, the recommendation, and the predicted success of the recommendation; receive a selection of a candidate well in response to the rank and predicted success of the recommendation; and schedule the action for intervention for the candidate well.

In some implementations, a computer-readable storage medium including instructions that, when executed by a processor, cause the processor to: perform, using a machine learning model, analysis on data for wells in a field; automatically identify, using the machine learning model, candidate wells for intervention opportunities in response to the analysis; perform, using the machine learning model, an analytic hierarchy process that uses a set of key performance indicators to generate a rank for the candidate wells; generate, using the machine learning model, a recommendation for the candidate wells and a predicted success of the recommendation, wherein the recommendation includes an action for intervention; display, on a user interface, the rank of the candidate wells, the recommendation, and the predicted success of the recommendation; receive a selection of a candidate well in response to the rank and predicted success of the recommendation; and schedule the action for intervention for the candidate well.

One or more specific implementations of the present disclosure are described herein. These described implementations are examples of the presently disclosed techniques. Additionally, in an effort to provide a concise description of these implementations, not all features of an actual implementation may be described in the specification. It should be appreciated that in the development of any such actual implementation, as in any engineering or design project, numerous implementation-specific decisions will be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. There is no intention to invoke means-plus-function or other functional claiming for any claim except for those in which the words ‘means for’ appear together with an associated function. Each addition, deletion, and modification to the implementations that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements. Additionally, as used herein, the term “and/or” includes any and all combinations of one or more of the associated listed items.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
performing, using a machine learning model, analysis on data for wells in a field;
automatically identifying, using the machine learning model, candidate wells for intervention opportunities in response to the analysis;
performing, using the machine learning model, an analytic hierarchy process that uses a set of key performance indicators to generate a rank for the candidate wells;
generating, using the machine learning model, a recommendation for the candidate wells and a predicted success of the recommendation, wherein the recommendation includes an action for intervention;
displaying, on a user interface, the rank of the candidate wells, the recommendation, and the predicted success of the recommendation;
receiving a selection of a candidate well in response to the rank and predicted success of the recommendation; and
scheduling the action for intervention for the candidate well.

2. The method of claim 1, wherein the machine learning model performs a plurality of petroleum engineering analysis on the data to generate a gain estimation of production for each candidate well.

3. The method of claim 1, wherein the analysis includes one or more of a decline curve (DCA) analysis, a type well (TW) analysis, a heterogeneity index (HI) analysis, Chan plot analysis, productivity index analysis, a voidage replacement ratio (VRR) plot analysis, an after-before-compact (ABC) plot analysis, a hall plot analysis, a well status analysis, a remaining reservoir (RR) analysis, a permeability times pay thickness (kh) analysis, water cut analysis, behind-casing-opportunity (BCO) analysis, reservoir analysis, and petrophysical analysis.

4. The method of claim 1, wherein the analytic hierarchy process further includes:
defining a decision hierarchy of key performance indicators to use in determining the rank;
receiving a priority for each key performance indicator in response to a pairwise comparison of the key performance indicators;
calculating a weight for each key performance indicator using the priority;
performing a consistency check of the weight for each key performance indicator;
calculating a final ranking score for the candidate wells using the weight for each key performance indicator; and
using the final ranking score to rank of the candidate wells.

5. The method of claim 1, wherein the key performance indicators include performance key performance indicators, ratio key performance indicators, and potential key performance indicators.

6. The method of claim 1, further comprising:
identifying, using the machine learning model, constraints of the candidate wells, wherein the constraints identify a cause of a production issue in the candidate wells; and
generating, using the machine learning model, the action in the recommendation in response to the constraints.

7. The method of claim 1, further comprising:
receiving intervention gains, intervention costs, and a duration of the intervention in response to performing the action on the candidate well; and
providing feedback to the machine learning model to use the intervention gains, the intervention costs, and the duration of the intervention in improving future recommendations and future predictions of success for the candidate wells.

8. The method of claim 1, wherein the data is multidisciplinary data obtained from different data sources and is consolidated into a single database for use by the machine learning model.

9. The method of claim 1, further comprising:
displaying, on the user interface, an insight with a snapshot of the data for the candidate wells, wherein the snapshot captures the data for a specific time frame.

10. The method of claim 1, wherein the action is a well-maintenance service to address a production issue in the candidate well to provide a production rate of the candidate well for a longer duration.

11. A system, comprising:
a memory to store data and instructions; and
a processor operable to communicate with the memory, wherein the processor is operable to:
perform, using a machine learning model, analysis on data for wells in a field;
automatically identify, using the machine learning model, candidate wells for intervention opportunities in response to the analysis;
perform, using the machine learning model, an analytic hierarchy process that uses a set of key performance indicators to generate a rank for the candidate wells;
generate, using the machine learning model, a recommendation for the candidate wells and a predicted success of the recommendation, wherein the recommendation includes an action for intervention;
display, on a user interface, the rank of the candidate wells, the recommendation, and the predicted success of the recommendation;
receive a selection of a candidate well in response to the rank and predicted success of the recommendation; and
schedule the action for intervention for the candidate well.

12. The system of claim 11, wherein the system is a multi-tenant system with a plurality of tenants and the processor is further operable to:
partition the data for each tenant to prevent unauthorized access to the data;
customize the analysis performed on the data for each tenant; and
customize the user interface displayed for each tenant.

13. The system of claim 12, wherein the processor is further operable to:
display a first user interface for a first tenant with a first snapshot of the data of the first tenant;
display a second user interface for a second tenant with a second snapshot of the data of the second tenant; and
display a third user interface for a third tenant with a third snapshot of the data of the third tenant.

14. The system of claim 11, wherein the analysis includes one or more of a decline curve (DCA) analysis, a type well (TW) analysis, a heterogeneity index (HI) analysis, Chan plot analysis, productivity index analysis, a voidage replacement ratio (VRR) plot analysis, an after-before-compact (ABC) plot analysis, a hall plot analysis, a well status analysis, a remaining reservoir (RR) analysis, a permeability times pay thickness (kh) analysis, water cut analysis, behind-casing-opportunity (BCO) analysis, reservoir analysis, and petrophysical analysis.

15. The system of claim 11, wherein the processor is further operable to perform the analytic hierarchy process by:
defining a decision hierarchy of key performance indicators to use in determining the rank;
receiving a priority for each key performance indicator in response to a pairwise comparison of the key performance indicators;
calculating a weight for each key performance indicator using the priority;
performing a consistency check of the weight for each key performance indicator;
calculating a final ranking score for the candidate wells using the weight for each key performance indicator; and
using the final ranking score to rank of the candidate wells.

16. The system of claim 11, wherein the key performance indicators include performance key performance indicators, ratio key performance indicators, and potential key performance indicators.

17. The system of claim 11, wherein the processor is further operable to:
identify, using the machine learning model, constraints of the candidate wells, wherein the constraints identify a cause of a production issue in the candidate wells; and
generate, using the machine learning model, the action in the recommendation in response to the constraints.

18. The system of claim 11, wherein the processor is further operable to:
receive intervention gains, intervention costs, and a duration of the intervention in response to performing the action on the candidate well; and
provide feedback to the machine learning model to use the intervention gains, the intervention costs, and the duration of the intervention in improving future recommendations and future predictions of success for the candidate wells.

19. The system of claim 11, wherein the processor is further operable to:
display, on the user interface, an user interface widget with an insight for the candidate wells.

20. The system of claim 11, wherein the action is a well-maintenance service to address a production issue in the candidate well to provide a production rate of the candidate well for a longer duration.
